(19) United States
(12) Patent Application Publication
(10) Pub. No.: US 2002/0182384 A1
(43) Pub. Date: Dec. 5, 2002

(54) Dry ink transfer system

(76) Inventor: Ralph Rhein, Racine, WI (US)

Correspondence Address: JANSSON, SHUPE & MUNGER, LTD, 245 MAIN STREET, RACINE, WI, 53403, US

(21) Appl. No.: 09/867,063

(22) Filed: May 29, 2001

(51) Int. Cl. B32B 27/14; B44C 1/00; B41M 1/00

(52) U.S. Cl. 428/204; 156/235; 156/277

(57) ABSTRACT

A dry ink transfer system is provided which allows for a very thin unsupported image to be transferred to a surface. Although unsupported, the image is able to endure large amounts of friction without image distortion or damage. Because the image is so thin, tactile discernment of its edges is impossible and friction forces against the image edges are substantially reduced. Although the method of transfer does not require heat, solvents, or high pressure, the adhesion between the image and the surface is very strong.

### FIELD OF THE INVENTION

The invention relates generally to images adhered to surfaces and the application of images onto receiving surfaces, and, more particularly, to such applications using transfer sheets.

### BACKGROUND OF THE INVENTION

Dry transfer systems are well known in the art of transferring images. They were developed as more convenient alternatives than the prior art water slide transfer systems. The water slide transfer systems are awkward in use and difficult to store under typical atmospheric conditions.

Most of the dry transfer systems that have been developed utilize dry adhesives which are sensitive to pressure or heat. The heat-sensitive transfer sheets require additional equipment for heating the image where transfer is intended.

Dry transfer systems using pressure-sensitive adhesive often utilize a low-tack adhesive that is almost dry to the touch. Typically the bonding affected by such adhesives is weak, and the images secured thereby are easily damaged or removed by abrasion.

A typical dry transfer sheet includes a backing layer secured to a graphic-depicting material which is applied to a support substrate, often vinyl. Adhesive can be affixed to the graphic-depicting material so that the graphic adheres to the support substrate. Adhesive can also be applied to the other side of the support substrate to create a bond between the support substrate and the receiving surface, enabling transfer of the graphic-depicting material and the carrier substrate from the backing layer to the receiving surface. In such a system, the adhered image, after transfer, comprises the graphic-depicting material adhered to the support substrate, which is adhered to the receiving surface.

One problem typical of such dry transfer systems is the eventual non-adhesion of the edges of the image, and eventually the entire image, to the receiving surface due to abrasive forces repeatedly engaging the edges of the support substrate and/or the graphic-depicting material. Though the image is provided with greater cohesive strength through the integrity offered by the support substrate, the consequent increase in the thickness of the transferred image results in a shorter life expectancy. This is due to the increased friction encountered by edges which project out farther from the receiving surface.

For instance, the surface which receives the image may be the hood of an automobile. An image at this location undergoes friction from wind, precipitation, wash mitts and chamois, as well as people who tend to pick at images secured to surfaces. Airplane and boat surfaces can encounter much higher friction forces than those encountered by automobiles.

Such images are often adhered to floor surfaces as well. In these applications, the vinyl layer supplies the image with lateral support and prevents the deterioration of the image caused by the forces associated with people and objects traveling over it. However, adhered images with raised edges inherently do not perform well under these circumstances.

Some dry transfer systems have eliminated the use of a support substrate. In other words, only the graphic-receiving material and adhesive remain bonded to the receiving surface after application of the transfer. Such systems are disclosed in U.S. Pat. No. 3,212,913 to Mackenzie and U.S. Pat. No. 3,945,141 to Frost.

Mackenzie and Frost disclose dry transfer systems wherein ink forming an indicia and adhesive are transferred from a backing layer to a receiving surface upon the application of substantial pressure from behind the carrier. This transfer is accomplished through the stretching of the backing layer which loosens the bond between the ink and the backing layer and results in the ability of the adhesive to adhere the ink to the receiving surface. Mackenzie and Frost both disclose that the image adhered to the receiving surface can be easily removed by applying pressure-sensitive tape over the image and then removing the tape along with the image.

As is evident, these systems do not provide sufficient adhesion to endure the forces encountered by images on receiving surfaces such as those described above where forces much greater than that applied by pressure-sensitive tape may pull at the image.

Another problem encountered in these prior art systems is that the stretching of the backing layer necessary to affect transfer often damages or distorts the image.

In addition, because adhesion and cohesiveness have been sacrificed for thinness, the image often “bubbles” or loses adhesion to the receiving surface along its interior. This problem usually involves the deformation and stretching of the image due to friction normal or lateral to the image surface and the loss of adhesiveness. Bubbling of the image also typically occurs after a period of time in which the image is exposed to various changes in environment, such as exposure to extremes in heat and cold or exposure to humidity, water or ice. Again, such exposure is regularly encountered by the receiving surfaces addressed above.

Another problem of typical dry transfer systems deals with the application of the image to the receiving surface. Often dry transfer systems require prolonged rubbing of the back of the backing layer in order to effect adhesion between the carrier substrate and the receiving surface. For instance, in U.S. Pat. No. 4,275,104 to de Nagybaczon, the film of indicia-forming material transfers to a receiving surface upon burnishing of the backing layer against the receiving surface. This burnishing deforms the indicia-forming material so that the material is pushed into the interstices of the receiving surface. While the application of repeated pressure utilized in burnishing can allow for increased adhesion, such deformation of the indicia-forming material can distort the image, especially when the image includes precise pigment distinctions or fine designs.

An improved dry transfer system which addresses these problems of known transfer systems would be an important advance in the art.

### OBJECTS OF THE INVENTION

It is an object of the invention to provide a dry ink transfer system overcoming some of the problems and shortcomings of prior art dry ink transfers.

Another object of the invention is to provide a method of transferring an image from an image-receiving substrate to a smooth surface without the necessary use of any tools which heat or provide high pressure to affect transfer.

Another object of the invention is to provide a method of transferring an image from an image-receiving substrate to a smooth surface which is efficient and easy.

Another object of the invention is to provide a method of transferring an image from an image-receiving substrate to a smooth surface wherein only the image and adhesive are bonded to the surface.

Another object of the invention is to provide a method of transferring an image from an image-receiving substrate to a smooth surface wherein the transferred image and adhesive are unsupported.

Still another object of the invention is to provide a method of transferring an image from an image-receiving substrate to a surface wherein the total thickness of the material bonded to the surface is sufficiently thin as to prevent tactile discernment of the image from the surface.

Another object of the invention is to provide a method of transferring an image from an image-receiving substrate to a surface wherein the transferred image is so strongly adhered that it can withstand high levels of friction for extended periods of time.

Another object of the invention is to provide a method of transferring an image from an image-receiving substrate to a surface wherein the user can precisely position the image onto the surface before transfer is affected.

Yet another object of the invention is to provide a method of transferring an image from an image-receiving substrate to a surface wherein the image is not deformed or otherwise damaged by the method of transfer.

How these and other objects are accomplished will become apparent from the following descriptions and the drawings.

### SUMMARY OF THE INVENTION

The new graphic transfer sheet and method of construction and use are intended to result in an extremely thin transferred image which indelibly adheres to a surface so that it cannot be removed without use of heat, solvents, or sharp tools. The method of bonding the image to a surface comprises the steps of (1) printing or otherwise applying the image onto an image-receiving substrate, (2) applying a first side of an adhesive layer onto the image, (3) securing a backing layer to the second side of the adhesive layer so that the adhesive does not adhere to an unintended surface; (4) detaching the backing layer from the adhesive after the adhesive has been applied to the image; (5) contacting the exposed adhesive to the surface; and (6) removing the image-receiving substrate so that the image remains bonded to the surface.

The adhesive layer is comprised solely by an adhesive. The adhesive can be printed onto the image before the backing layer is secured onto it; however, in the preferred embodiment the backing layer is secured to the adhesive before the adhesive layer is laid down over the image. The method also provides that the graphic transfer sheet can be stored and/or transported after step 3, so that the sheet is ready to affect transfer whenever and wherever the user desires.

The adhesive preferably has low tackiness. Low tackiness allows the adhesive layer to be placed on the surface and moved to the intended position before light pressure is applied to the back of the image-receiving substrate to affect the contact of the adhesive to the surface. While the adhesive has low tackiness, once contacted it has a high level of adhesion to surfaces such as steel, glass, acrylics, plastics and other smooth surfaces. Its preferred adhesion can range from about 30-95 oz/in.

The low tackiness of the adhesive requires that the image transferor apply pressure to the image in order to affect contact. The low amount of pressure applied does not cause the image to deform or the image-receiving substrate to stretch. In fact, the amount of pressure necessary is so low that for small images it could be applied manually by the transferor. However, in typical large applications the transferor preferably uses a flat-ended tool such as a squeegee. The squeegee is preferred, not because of an increase in force applied, but due to the ability to apply low pressure evenly and widely so as to efficiently affect adhesion.

The image-receiving substrate is preferably a clear polymeric film, preferably polyester, and has a release-finish on the side on which the image is applied. The release-finish can be a release-coating, which remains on the image-receiving substrate when removed from the image, or a breakaway-coating, which remains on the image when the image-receiving substrate is removed. The behavior of the breakaway-coating can better ensure that the image is not damaged by the removal of the image-receiving substrate; however, the breakaway-coating does not offer any structural support to the image.

The breakaway-coating assimilates with the image so that the presence of the breakaway-coating in the bonded composite of the image and adhesive does not substantially affect the thinness of the composite. A preferred thickness of the adhered composite (the image and adhesive) is less than about 5 mils. A more preferred thickness of the adhered composite is less than about 3 mils. A preferred thickness of the adhered composite including the breakaway-coating is less than about 5 mils. A more preferred thickness of the adhered composite including the breakaway-coating is less than about 3 mils.

The image can comprise a letter, word, insignia, design, picture or any other graphic. The image is preferably ink which is reverse-screen printed onto the image-receiving substrate so that the later application to a surface results in the correct orientation of the image. It is preferred that multi-colored images be produced from the multiple printing of different inks in succession. The image can also be comprised of non-ink pigments or dyes, as long as the image is able to attach to the image-receiving substrate, be overlaid with adhesive and be transferred to a surface without cracking or deteriorating.

The method can also include another step in which the adhered image (with or without the breakaway-coating) is coated with a clear-coat. The preferred clear-coat is a liquid which is applied to the image and a portion of the surface surrounding the image. The clear-coat acts to lessen the already nearly imperceptible edge of the adhered image so that any tactile discernment of the image from the surface is eliminated. The thickness of the clear-coat on the image is less than about 2 mils. The clear-coat is thicker on the surface adjacent to the image and tapers down to the periphery of the clear-coat so that there is no discernible edge to the image.

The surface on which the image is applied is preferably smooth, so that the unsupported adhered image lies evenly on the surface. The surface does not need to be planar because the image and adhesive layer have great flexibility in wrapping around curved surfaces. Surfaces which are sufficient for effective transfer include vehicle surfaces, such as external and internal surfaces in automobiles, airplanes, or ships; building surfaces, such as walls, ceilings, windows, roofs, or floors; and other smooth surfaces.

### BRIEF DESCRIPTION OF THE DRAWINGS

FIG. 1 is a cross-sectional view of a dry ink transfer sheet, depicting the removal of the backing layer from the adhesive layer.

FIG. 2 is a cross-sectional view of a dry ink image applied to a receiving surface.

FIG. 3 is a cross-sectional view of a dry ink image applied to a receiving surface, depicting the removal of the image-receiving layer with the breakaway-coating remaining on the image.

FIG. 4 is a cross-sectional view of a dry ink image applied to a receiving surface, depicting the removal of the image-receiving layer and release-coating.

FIG. 5 is a cross-sectional view of a dry ink image applied to a receiving surface and covered with a clear-coat.

### DETAILED DESCRIPTION OF PREFERRED EMBODIMENTS

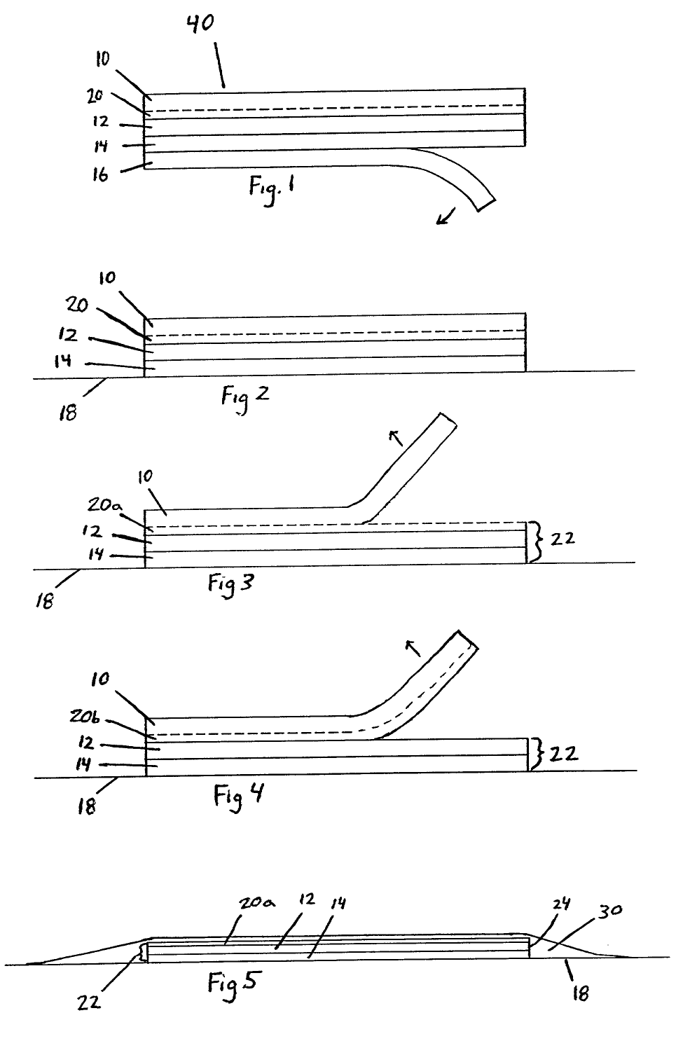

Referring to FIG. 1, details of the dry ink transfer system will be set forth. The dry ink transfer system includes use of a multilayered graphic transfer sheet 40. In the preferred method of construction, the image 12 is reverse-printed onto the release-finish 20 of an image-receiving substrate 10. The image 12 is reverse-printed so that it appears properly oriented when it is applied to the surface 18. Image 12 preferably comprises diverse inks printed successively to create the intended graphic. In the preferred embodiment, the image-receiving substrate 10 is a clear polymeric film. More specifically, the preferred image-receiving substrate 10 is clear polyester. The release-finish 20 may or may not be integral to the image-receiving substrate 10. The image-receiving substrate 10 is thin, on the order of 3 to 8 mils, though its thickness is not particularly important, as long as the substrate 10 is flexible enough to enable its eventual removal from the image 12 during application to the surface 18. The release-finish 20 is typically less than about 0.6 mils thick.

An adhesive layer 14 is applied onto the image 12. In the preferred embodiment the adhesive layer 14 covers the image 12 and the exposed areas of the release-finish 20 which are not covered by the image 12. However, the adhesive layer 14 could cover only the image and not the exposed release-finish. The adhesive layer 14 is preferably a permanent pressure-sensitive acrylic adhesive. In the preferred embodiment, the adhesive is between about 0.2-1.1 mils thick.

In the preferred embodiment, the adhesive layer 14 has a backing layer 16 affixed to its back side when the front side of the adhesive layer 14 is contacted to the image 12. However, the backing layer 16 could be affixed to the adhesive layer 14 after the adhesive layer 14 is applied to the image 12. The backing layer 16 is typically smooth clear polyester with a thickness of about 0.5-4.8 mils. The backing layer 16 offers a barrier between the adhesive layer 14 and other objects so that the adhesive layer 14 does not unintentionally contact and adhere to other objects.

FIG. 1 depicts the beginning of the removal of the backing layer 16 before the graphic transfer sheet 40 is placed on the intended surface 18.

FIG. 2 depicts the graphic transfer sheet 40 after the backing layer 14 has been removed and the adhesive layer 14 has been contacted to the surface 18. The adhesive layer 14 is preferably low-tack. A low level of tackiness allows the adhesive layer 14 to be placed on a receiving surface 18 without immediately causing adhesion. Using low-tack adhesive, the graphic transfer sheet 40 can be moved to the preferred area for adhesion and light pressure can be applied to the top of the image-receiving substrate 10 so that the adhesive layer 14 evenly and effectively adheres to the surface 18. This light pressure can be applied manually by the user, or by utilizing a flat-ended tool such as a squeegee. In the preferred embodiment the adhesive layer 14 has high adhesion to smooth surfaces such as metals, plastics, acrylics and glass. The preferred adhesion is at least about 50 oz./in.

FIG. 3 depicts the removal of the image-receiving substrate 10 from the adhered image 12. In FIG. 3 the release-liner 20 is a breakaway-coating 20a which breaks from the image-receiving substrate 10 and remains on the image 12. The breakaway-coating 20a merges (not shown) with the image 12 so that the presence of the breakaway-coating 20a does not substantially affect the thinness of the adhered composite 22. The adhered composite 22 remains bonded to the surface 18 when the image-receiving substrate 10 is removed because the adhesion between the adhesive layer 14 and the surface 18, the adhesion between the image 12 and the adhesive layer 14, and the adhesion between the breakaway-coating and the image 12 are greater than the adhesion between the image-receiving substrate 10 and the breakaway-coating 20a.

FIG. 4 depicts the removal of the image-receiving substrate 10 from the adhered image 12. In FIG. 3 the release-liner 20 is a release-coating 20b which releases from the image 12 and remains attached to the image-receiving substrate 10. The adhered composite 22 remains bonded to the surface 18 when the image-receiving substrate 10 is removed because the adhesion between the adhesive layer 14 and the surface 18 and the adhesion between the image 12 and the adhesive layer 14 are greater than the adhesion between the image 12 and the release-coating 20b.

FIG. 5 depicts the image 12 with the breakaway-coating 20a and adhesive layer 14 adhered to the surface 18. A clear-coat 30 has been applied over the composite 22 in order to eliminate the tactile discernment of the edges 24 of the composite 22. The clear-coat 30 tapers out to a very small thickness so that tactile discernment of the end of the clear-coat 30 is impossible.

What is claimed is:

1. A method of bonding an image to a surface comprising the steps of
printing the image onto an image-receiving substrate;
applying a first side of an adhesive layer onto the image;
securing a backing layer to a second side of the adhesive layer to prevent bonding of the second side to an unintended object;
detaching the backing layer from the second side after the first side has been applied to the image;
contacting the second side to the surface; and
removing the image-receiving substrate to leave the image bonded to the surface.

2. The method of claim 1 wherein the securing step is performed before the applying step.

3. The method of claim 1 wherein the first side of the adhesive layer is printed onto the image.

4. The method of claim 1 wherein the image is reverse-printed onto the image-receiving substrate.

5. The method of claim 1 wherein the image-receiving substrate is a substantially transparent polymeric film.

6. The method of claim 1 wherein the image-receiving substrate is coated with a release-finish, the image being printed onto the release-finish.

7. The method of claim 6 wherein the release-finish is a breakaway-coating that remains fastened to the image when the image-receiving substrate is removed.

8. The method of claim 6 wherein the release-finish is a release-coating that remains fastened to the image-receiving substrate when the image-receiving substrate is removed.

9. The method of claim 7 wherein the total thickness of the breakaway-coating, image and adhesive bonded to the surface is less than about 5 mils.

10. The method of claim 9 wherein the total thickness of the breakaway-coating, image and adhesive bonded to the surface is less than about 3 mils.

11. The method of claim 8 wherein the total thickness of the image and adhesive bonded to the surface is less than about 5 mils.

12. The method of claim 8 wherein the total thickness of the image and adhesive bonded to the surface is less than about 3 mils.

13. The method of claim 1 further comprising the additional step of coating the image bonded to the surface with a clear-coat.

14. The method of claim 11 wherein the clear-coat is a liquid.

15. The method of claim 11 wherein the thickness of the adhered image and the clear-coat combine to substantially eliminate any tactile discernment of any edge on the surface.

16. The method of claim 1 wherein the second side of the adhesive layer has low tackiness.

17. The method of claim 1 further comprising, between the contacting and removing steps, the step of applying pressure to the image-receiving substrate to facilitate adhesion to the surface.

18. The method of claim 1, wherein the surface is a vehicle surface.

19. The method of claim 18, wherein the surface is an automobile surface.

20. The method of claim 18, wherein the surface is a airplane surface.

21. The method of claim 1, wherein the surface is a building structure surface.

22. The method of claim 21, wherein the surface is a wall surface.

23. The method of claim 21, wherein the surface is a ceiling surface.

24. The method of claim 6, wherein the image, image-receiving substrate, release-finish and adhesive layer are mutually insoluble.

25. A transferred graphic indelibly bonded to a surface, comprising a composite of an image having outer and inner sides and an adhesive secured between the inner side and the surface, and a clear-coat overlying the composite and the surface.

26. The transferred graphic of claim 25 wherein the composite has a breakaway-coating affixed to the outer side of the image.

27. The transferred graphic of claim 25 wherein the total thickness of the composite and clear-coat is less than about 5 mils.

28. The transferred graphic of claim 27 wherein the total thickness of the composite and clear-coat is less than about 3 mils.

29. The transferred graphic of claim 26 wherein the total thickness of the composite and clear-coat is less than about 5 mils.

30. The transferred graphic of claim 29 wherein the total thickness of the composite and clear-coat is less than about 3 mils.

31. The transferred graphic of claim 25, wherein the ink image is comprised of multiple inks applied in succession to create a multi-colored image.

32. A graphic transfer sheet comprising:
an image-receiving substrate having first and second sides and a release-finish on the first side;
an image applied to the release-finish;
an adhesive layer affixed to the image, the adhesive layer and image having a combined thickness less than about 5 mils; and
a backing layer secured to the adhesive layer,
whereby the graphic transfer sheet is used to transfer and secure the image and adhesive layer, substrate-free, to a surface.

33. The transfer sheet of claim 32 wherein the image-receiving substrate is a transparent polymeric film.

34. The transfer sheet of claim 33 wherein the polymeric film is polyester.

35. The transfer sheet of claim 32 wherein the adhesive is a pressure-sensitive acrylic adhesive.

36. The transfer sheet of claim 32 wherein the backing layer is smooth polyester.

37. The transfer sheet of claim 32 wherein the release-finish is a release-coating that adheres more strongly to the image-receiving substrate when the image and adhesive layer are transferred to the surface.

38. The transfer sheet of claim 32 wherein the release-finish is a breakaway-coating that adheres more strongly to the image than to the image-receiving substrate, so that the breakaway-coating remains on the image when the image is secured to the surface and the image-receiving substrate is removed.

39. The transfer sheet of claim 38 wherein the combined thickness of the adhesive layer, image and breakaway-coating is less than about 5 mils.

40. The transfer sheet of claim 32 wherein the combined thickness of the adhesive layer and image is less than about 3 mils.

41. The transfer sheet of claim 39 wherein the combined thickness of the adhesive layer, image and breakaway-coating is less than about 3 mils.
